(19) United States
(12) Patent Application Publication
(10) Pub. No.: US 2022/0012180 A1
(43) Pub. Date: Jan. 13, 2022

(54) MEMORY SYSTEM FOR META DATA MANAGEMENT AND OPERATING METHOD OF MEMORY SYSTEM

(71) Applicant: SK hynix Inc., Gyeonggi-do (KR)

(72) Inventors: Ju Hyun KIM, Gyeonggi-do (KR); Jin Yeong KIM, Gyeonggi-do (KR)

(21) Appl. No.: 17/036,960

(22) Filed: Sep. 29, 2020

(30) Foreign Application Priority Data
Jul. 7, 2020 (KR) 10-2020-0083485

(51) Int. Cl. G06F 12/0891

(52) U.S. Cl. CPC G06F 12/0891; G06F 2212/1044

(57) ABSTRACT

A memory system comprising: a controller generates meta data in accordance with normal data being stored in a non-volatile memory device, and a buffer memory stores multiple meta slices configuring the meta data, the controller classifies an updated slice of the multiple meta slices as a first dirty slice, classifies a flushed slice of the first dirty slices as a second dirty slice, classifies a flushed slice of the second dirty slices as the meta slice and classifies an updated slice of the second dirty slices as a third dirty slice, classifies a flushed slice of the third dirty slices as the second dirty slice, and permits an update of each of the first to third dirty slices in a section in which a flush operation for each of the first to third dirty slices is performed.

### CROSS-REFERENCE TO RELATED APPLICATION

This application claims priority under 35 U.S.C. § 119 to Korean Patent Application No. 10-2020-0083485, filed on Jul. 7, 2020, which is incorporated herein by reference in its entirety.

### BACKGROUND

### 1. Field

Various embodiments relate to a memory system, and particularly, to a memory system for meta data management and an operating method of a memory system.

### 2. Discussion of the Related Art

The computer environment paradigm has changed to ubiquitous computing systems that can be used anytime and anywhere. As a result, use of portable electronic devices such as mobile phones, digital cameras, and notebook computers has rapidly increased. These portable electronic devices generally use a memory system having one or more memory devices for storing data. A memory system may be used as a main or an auxiliary storage device of a portable electronic device.

Memory systems provide excellent stability, durability, high information access speed, and low power consumption because they have no moving parts. Examples of memory systems having such advantages include universal serial bus (USB) memory devices, memory cards having various interfaces, and solid-state drives (SSDs).

### SUMMARY

Various embodiments are directed to a memory system capable of efficiently managing meta data and a method of managing the memory system.

In an embodiment, a memory system may include: a non-volatile memory device; a controller suitable for generating meta data in accordance with normal data being stored in the non-volatile memory device; and a buffer memory suitable for storing multiple meta slices configuring the meta data, the controller may classify each updated slice of the multiple meta slices as a first dirty slice using first state information of the corresponding updated slice, may classify each flushed slice of the first dirty slices as a second dirty slice by using the first and second state information of the corresponding flushed slice, may classify each flushed slice of the second dirty slices as the meta slice using the second state information of the corresponding flushed slice may classify each updated slice of the second dirty slices as a third dirty slice using the first state information of the updated slice, may classify each flushed slice of the third dirty slices as the second dirty slice using the first state information of the flushed slice, and may enable update of each of the first to third dirty slices while flushing each of the first to third dirty slices. The first and second state information for each of the multiple meta slices may be stored in the buffer memory.

The controller may generate first journal data comprising information on the update of the first to third dirty slices and stores the first journal data in the buffer memory, may flush at least one of the first to third dirty slices when the at least one dirty slice is present in a state in which the first journal data has a size smaller than a set size, may flush the first journal data by changing the first journal data into journal retention data when the first journal data has the set size, and may generate second journal data comprising update information on the first to third dirty slices after the flushing of the first journal retention data is started, and may store the second journal data in the buffer memory.

The second journal data may be stored in a different location in the buffer memory than the location at which the journal retention data is stored in the buffer memory.

The controller may flush at least one of the first to third dirty slices by writing at least one of the first to third dirty slices. The controller may flush the journal retention data by writing the journal retention data in the non-volatile memory device.

The controller may flush at least one of the first to third dirty slices in a state in which the first journal data has a size smaller than a set size by: moving the at least one of the first to third dirty slices to a reserved space of the buffer memory, and writing, when flushing the journal retention data, the at least one of the first to third dirty slices moved to the reserved space together with the journal retention data in the non-volatile memory device.

The controller may move the at least one of the first to third dirty slices by: splitting the at least one of the first to third dirty slices by a size unit, and moving the split slices at set times.

The controller may check a size of the first journal data at the time at which moving of the at least one of the first to third dirty slices to the reserved space is started, and may determine the size unit and the set times based on a result of the check.

The controller: may search the multiple meta slices for the first to third dirty slices in a round robin manner, and may flush the first to third dirty slices retrieved in the search.

The controller may search for the first to third dirty slices from a next meta slice of a previously retrieved meta slice, when the second journal data is generated after the flushing of the journal retention data is started.

The controller: may set initial values of the first and second state information to “0” and “0”, respectively, may classify each of the first dirty slices by setting a value of the first state information of the updated slice to “1”, may classify each of the second dirty slices by setting values of the first and second state information of the flushed slice to “0” and “1”, respectively, may classify each of the meta slices by setting a value of the second state information of the flushed slice to “0”, may classify each of the third dirty slices by setting a value of the first state information of the updated slice to “1”, and may classify each of the second dirty slices by setting a value of the first state information of the flushed slice to “0.”

In an embodiment, an operating method of a memory system comprising a non-volatile memory device and a buffer memory, the operating method may include: generating meta data configured with multiple meta slices in accordance with normal data being stored in the non-volatile memory device; storing the meta data and the first and second state information in the buffer memory; classifying, in a first classifying operation, each updated slice of the multiple meta slices as a first dirty slice using first state information of the corresponding updated slice; classifying, in a second classifying operation, each flushed slice of the first dirty slices as a second dirty slice using the first information and second state information of the corresponding flushed slice; classifying, in a third classifying operation, each flushed slice of the second dirty slices as the meta slice using the second state information of the corresponding flushed slice; classifying, in a fourth classifying operation, each updated slice of the second dirty slices as a third dirty slice using the first state information of the corresponding updated slice; and classifying, in a fifth classifying operation, each flushed slice of the third dirty slices as the second dirty slice using the first state information of the corresponding flushed slice. Update of each of the first to third dirty slices may be enabled while flushing each of the first to third dirty slices.

The operating method may further include: generating first journal data comprising information of the update of the first to third dirty slices and storing the first journal data in the buffer memory; flushing, in a first flush operation, at least one of the first to third dirty slices when the at least one dirty slice is present in a state in which the first journal data has a size smaller than a set size; flushing, in a second flush operation, the first journal data by changing the first journal data to journal retention data when the first journal data has the set size; and generating second journal data comprising update Is information corresponding to the first to third dirty slices after the flushing of the first journal retention data is started, and storing the second journal data in the buffer memory,

The second journal data may be stored in a different location in the buffer memory than the location at which the journal retention data is stored in the buffer memory.

The first flush operation may include writing any one of the first to third dirty slices in the non-volatile memory device, and the second flush operation may include writing the journal retention data in the non-volatile memory device.

The first flush operation may include: moving the at least one of the first to third dirty slices to a reserved space of the buffer memory, and writing, during the second flush operation, the at least one of the first to third dirty slices moved to the reserved space together with the journal retention data in the non-volatile memory device.

The moving of the at least one of the first to third dirty slices may include: splitting the at least one of the first to third dirty slices by a size unit, and moving the split slices at set times.

The operating method may further include: checking a size of the first journal data at the time at which moving of the at least one of the first to third dirty slices to the reserved space is started, and determining the size unit and the timing based on a result of the checking.

The operating method may further include searching the multiple meta slices for the first to third dirty slices in a round robin manner, In a first flush operation may be performed on the searched first to third dirty slices.

The first to third dirty slices may be searched from a meta slice next to one among the first to third dirty slices that is previously searched when the second journal data is generated after the flushing of the journal retention data is started.

The operating method may further include: setting initial values of the first and second state information to “0” and “0”, respectively. In the first classification operation, the first dirty slices may be classified by setting a value of the first state information of the updated slices among the multiple meta slices to “1”, in the second classification operation, the second dirty slices may be classified by setting values of the first and second state information of the flushed slices among the first dirty slices to “0” and “1”, respectively, in the third classification operation, the meta slices may be classified by setting a value of the second state information of the flushed slices among the second dirty slices to “0”, in the fourth classification operation, the third dirty slices may be classified by setting a value of the first state information of the updated slices among the second dirty slices to “1”, and in the fifth classification operation, the second dirty slices may be classified by setting a value of the first state information of the flushed slices among the third dirty slices to “0.”

In an embodiment, a control system may include: a meta memory suitable for caching meta information of plural meta slices; a journal memory including first and second regions; and a controller suitable for: updating one of the meta slices; marking the updated slice as dirty; caching journal data in the first region, the journal data representing the update; and flushing the meta information and the cached journal data alternately. The controller may be flush the meta information by: searching the slices in a round robin manner for a dirty slice; flushing the dirty slice; marking the flushed slice as clean without updating the dirty slice during the flushing of the dirty slice; and keeping the flushed slice as dirty and updating the dirty slice during the flushing of the dirty slice. The controller may be cache subsequent journal data in the second region when the first region becomes full of the cached journal data. The controller may be flush the cached journal data from the first region, which becomes full of the cached journal data, to remove the flushed journal data.

### BRIEF DESCRIPTION OF THE DRAWINGS

FIG. 1 illustrates a structure of a data processing system including a memory system according to an embodiment.

FIG. 2 schematically illustrates an example of a data processing system including a memory system according to an embodiment.

FIG. 3 illustrates an example of a data processing operation which may be performed on a memory device in a memory system according to an embodiment.

FIG. 4 illustrates the structure of meta data in a memory system according to an embodiment.

FIGS. 5A to 5G illustrate a method of managing meta data in a memory system according to an embodiment.

### DETAILED DESCRIPTION

Various examples of the disclosure are described below in more detail with reference to the accompanying drawings. Aspects and features of the present technology, however, may be embodied in different ways to form other embodiments, including variations of any of the disclosed embodiments. Thus, the present invention is not limited to the embodiments set forth herein. Rather, the described embodiments are provided so that this disclosure is thorough and complete, and fully conveys the disclosure to those skilled in the art to which the technology pertains. Throughout the disclosure, like reference numerals refer to like parts throughout the various figures and examples of the disclosure. It is noted that reference to “an embodiment,” “another embodiment” or the like does not necessarily mean only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element in one instance could be termed a second or third element in another instance without indicating any change in the element itself.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via one or more intervening elements therebetween. In addition, it will also be understood that when an element is referred to as being “between” two elements, it may be the only element between the two elements, or one or more intervening elements may also be present.

The terminology used herein is for the purpose of describing particular embodiments only and is not intended to limit the invention. As used herein, singular forms are intended to include the plural forms and vice versa, unless the context clearly indicates otherwise. Similarly, the indefinite articles “a” and “an” mean one or more, unless it is clear from the language or context that only one is intended.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the technology belongs in view of the disclosure. It will be further understood that terms, such as those defined in commonly used dictionaries, should be interpreted as having a meaning that is consistent with their meaning in the context of the disclosure and the relevant art, and not be interpreted in an idealized or overly formal sense unless expressly so defined herein.

In the following description, numerous specific details are set forth in order to provide a thorough understanding of the technology. The technology may be practiced without some or all of these specific details. In other instances, well-known process structures and/or processes have not been described in detail in order not to unnecessarily obscure the subject matter of the invention.

It is also noted, that in some instances, as would be apparent to those skilled in the relevant art, a feature or element described in connection with one embodiment may be used singly or in combination with other features or elements of another embodiment, unless otherwise specifically indicated,

Embodiments of the disclosure are described in detail below with reference to the accompanying drawings, wherein like numbers reference like elements.

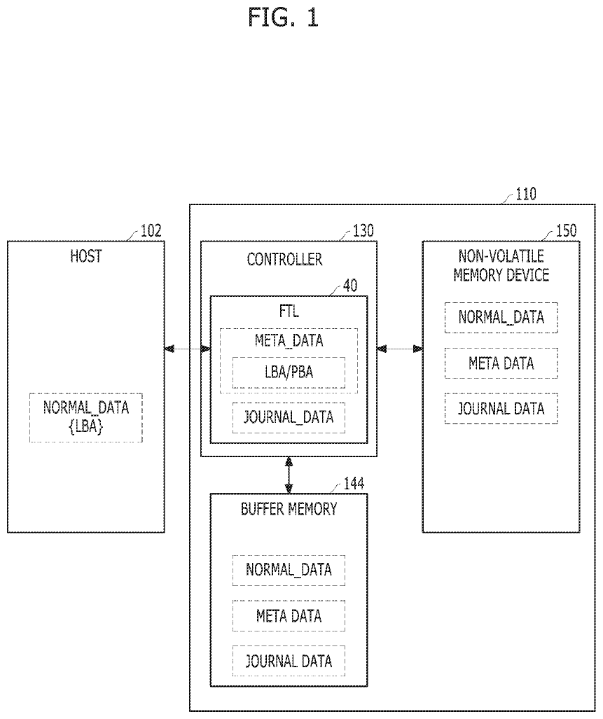

FIG. 1 illustrates a structure of a data processing system including a memory system according to an embodiment.

Referring to FIG. 1, a data processing system 100 may include a host 102 and a memory system 110 operably coupled to the host 102, The host 102 may be a computing device, which may be realized in the form of a mobile device, a computer, or a server. The memory system 110 may receive a command from the host 102 and may store or output data corresponding to the received command.

The memory system 110 may have a storage space which may include nonvolatile memory cells. For example, the memory system 110 may be realized in the form of a flash memory, or a solid-state drive (SSD).

In order to store data requested by the host 102, the memory system 110 may perform a mapping operation that couples a file system used by the host 102 with the storage space including the nonvolatile memory cells. An address of data according to the file system used by the host 102 may be referred to as a logical address or a logical block address. An address of data in the storage space including nonvolatile memory cells may be referred to as a physical address or a physical block address. When the host 102 transmits a logical address together with a write command and data to the memory system 110, the memory system 110 may search the storage space for a location for storing the data, may map a physical address of the identified location in the storage space with the logical address, and may program the data in the identified location. When the host 102 transmits a logical address together with a read command to the memory system 110, the memory system 110 may search for a physical address mapped to the logical address, and may output data stored in the physical address found in the search, to the host 102.

Specifically, the memory system 110 may include a non-volatile memory device 150 which retains stored data even without the supply of power, a buffer memory 144 for temporarily storing data, and a controller 130 for controlling operations of the non-volatile memory device 150 and the buffer memory 144. Furthermore, the controller 130 may include a flash translation layer (FTL) 40.

More specifically, the host 102 may manage normal data NORMAL_DATA using a logical address LBA. Furthermore, the controller 130 in the memory system 110 may store, in the non-volatile memory device 150, the normal data NORMAL_DATA received from the host 102. In this case, the controller 130 may map the logical address LBA, received from the host 102 along with the normal data NORMAL_DATA, to a physical address PBA indicative of a physical space within the non-volatile memory device 150 in which the normal data NORMAL_DATA is stored.

As described above, the controller 130 may generate meta data META DATA in accordance with the storage of the normal data NORMAL_DATA through a mapping operation. That is, the controller 130 may generate, as the meta data META DATA, mapping information LBA/PBA for mapping the logical address LBA of the normal data NORMAL_DATA to the physical address PBA indicative of the physical space within the non-volatile memory device 150. In this case, the mapping information LBA/PBA included in the meta data META DATA may also be updated in response to the update of the normal data NORMAL_DATA within the non-volatile memory device 150. Furthermore, the controller 130 may store, in the non-volatile memory device 150, the meta data META DATA generated therein.

Furthermore, the controller 130 may generate journal data JOURNAL_DATA, which may represent an update history of the meta data META DATA. Accordingly, the controller 130 may recover a previous version of the meta data META DATA based on the journal data JOURNAL_DATA. Furthermore, the controller 130 may store, in the non-volatile memory device 150, the journal data JOURNAL_DATA generated therein.

Furthermore, the operation of generating the meta data META DATA by mapping the logical address LBA to the physical address PBA and the operation of generating the journal data JOURNAL_DATA by collecting the history information for the update contents of the meta data META DATA may be performed by the FTL 40 in the controller 130.

Furthermore, the normal data NORMAL.. DATA input and output between the host 102 and the memory system 110 may be temporarily stored in the buffer memory 144 in the controller 130, separately from the storage of the normal data NORMAL_DATA in the non-volatile memory device 150. Furthermore, the meta data META DATA generated by the controller 130 in accordance with the storage of the normal data NORMAL_DATA received from the host 102 may be temporarily stored in the buffer memory 144 in the controller 130, separately from the storage of the meta data META DATA in the non-volatile memory device 150. Furthermore, the journal data JOURNAL_DATA generated by the controller 130 in accordance with an operation of updating the meta data META DATA may be temporarily stored in the buffer memory 144 in the controller 130, separately from the storage of the journal data JOURNAL_DATA in the non-volatile memory device 150.

For reference, FIG. 1 illustrates that the buffer memory 144 is disposed externally to the controller 130, but this is merely an embodiment. According to another embodiment, the buffer memory 144 may be included within the controller 130.

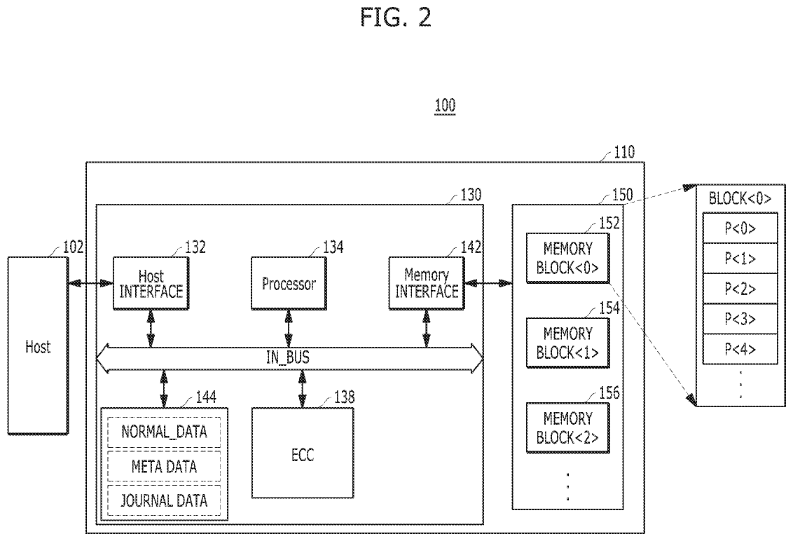

FIG. 2 schematically illustrates an example of the data processing system including the memory system according to an embodiment.

Referring to FIG. 2, the data processing system 100 may include a host 102 coupled to the memory system 110.

The host 102 may be implemented as any of various electronic devices, for example, a portable electronic device such as a mobile phone, an MP3 player and a laptop computer or a non-portable electronic device such as a desktop computer, a game machine, a television (TV) and a projector, that is, wired and wireless electronic devices.

The host 102 may include at least one operating system (OS) for managing and controlling the function and operation of the host 102, and providing interoperability between the host 102 and a user using the data processing system 100 or the memory system 110. The operating system may support functions and operations corresponding to the user's purpose of use and the use of the operating system. For example, the operating system may be classified into a general operating system and a mobile operating system depending on the mobility of the host 102. Also, the general operating system may be classified into a personal operating system and an enterprise operating system depending on the user's usage environment. For example, the personal operating system characterized to support a service providing function for a general user may include Windows and Chrome, and the enterprise operating system characterized to secure and support high performance may include Windows server, Linux and Unix. In addition, the mobile operating system characterized to support a mobility service providing function and a system power saving function to users may include Android, iOS, Windows mobile, etc. The host 102 may include a plurality of operating systems, and may execute the operating systems to perform operations with the memory system 110 corresponding to a user request. The host 102 may transmit a plurality of commands corresponding to a user request to the memory system 110, and accordingly, the memory system 110 may perform operations corresponding to the commands, that is, operations corresponding to the user request.

The memory system 110 may operate in response to a request of the host 102, in particular, may store data to be accessed by the host 102. The memory system 110 may be used as a main memory device or an auxiliary memory device of the host 102. The memory system 110 may be realized as any of various types of storage devices, depending on a host interface protocol which is coupled with the host 102. For example, the memory system 110 may be realized as a solid-state drive (SSD), a multimedia card in the form of an MMC, an embedded MMC (eMMC), a reduced size MMC (RS-MMC) and a micro-MMC, a secure digital card in the form of an SD, a mini-SD and a micro-SD, a universal serial bus (USB) storage device, a universal flash storage (UFS) device, a compact flash (CF) card, a smart media card, or a memory stick.

The storage devices which realize the memory system 110 may be realized by a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable and programmable ROM (EEPROM), an ferroelectric random access memory (FRAM), a phase change RAM (PRAM), a magnetic RAM (MRAM) and/or a resistive RAM (RRAM).

The memory system 110 may include a memory device 150 which may store data to be accessed by the host 102, and a controller 130 which may control storage of data in the memory device 150.

The controller 130 and the memory device 150 may be integrated into one semiconductor device to configure an SSD. When the memory system 110 is used as an SSD, the operating speed of the host 102 which is coupled to the memory system 110 may be improved. In another embodiment, the controller 130 and the memory device 150 may be integrated into one semiconductor device to configure a memory card, such as a PC card (e.g., Personal Computer Memory Card International Association (PCMCIA) card), a compact flash card (CF), a smart media card (e.g., SM and SMC), a memory stick, a multimedia card (e.g., MMC, RS-MMC and MMCmicro), a secure digital (SD) card (e.g., SD, miniSD, microSD and SDHC) and/or a universal flash storage (UFS).

In another embodiment, the memory system 110 may configure a computer, an ultra mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various component elements configuring a computing system.

The memory device 150 may retain stored data even though power is not supplied. In particular, the memory device 150 may store the data provided from the host 102, through a write operation, and provide stored data to the host 102, through a read operation. The memory device 150 may include a plurality of memory blocks 152, 154 and 156. Each of the memory blocks 152, 154 and 156 may include a plurality of pages including P<0> to P<4>. Each of the pages including P<0> to P<4> may include a plurality of memory cells. The memory blocks 152, 154 and 156 include page buffers for caching data to be inputted/outputted, by a unit of a page. The memory device 150 may include a plurality of planes in each of which some of the plurality of memory blocks 152, 154 and 156 are included. The memory device 150 may include a plurality of memory dies in each of which one or more of the plurality of planes are included. The memory device 150 may be a nonvolatile memory device, for example, a flash memory. The flash memory may have a three-dimensional (3D) stack structure.

The memory device 150 may include a plurality of memory blocks. Each of the plurality of memory blocks may be implemented as any of various types, such as a single level cell (SLC) memory block and a multi level cell (MLC) memory block, according to the number of bits that can be stored or represented in one memory cell of that memory block. An SLC memory block may include a plurality of pages implemented by memory cells, each storing one bit of data. An SLC memory block may have high performance for data input and output (I/O) operations and high durability. An MLC memory block may include a plurality of pages implemented by memory cells, each storing multi-bit data (e.g., two bits or more). An MLC memory block may have larger storage capacity in the same space than the SLC memory block. The MLC memory block may be highly integrated in terms of storage capacity. In an embodiment, the memory device 150 may be implemented with MLC memory blocks such as an MLC memory block, a triple level cell (TLC) memory block, a quadruple level cell (QLC) memory block and a combination thereof. The MLC memory block may include a plurality of pages implemented by memory cells, each capable of storing 2-bit data. The triple level cell memory block may include a plurality of pages implemented by memory cells, each capable of storing 3-bit data. The quadruple level cell memory block may include a plurality of pages implemented by memory cells, each capable of storing 4-bit data. In another embodiment, the memory device 150 may be implemented with a block including a plurality of pages implemented by memory cells, each capable of storing 5-bit data or more.

In an embodiment, the memory device 150 is embodied as a nonvolatile memory, for example, a flash memory, such as a NAND flash memory and a NOR flash memory. However, the memory device 150 may be implemented by at least one of a phase change random access memory (PCRAM), a ferroelectric random access memory (FRAM) and a spin transfer torque magnetic random-access memory (STT-RAM or STT-MRAM).

The controller 130 may control the memory device 150 in response to a request from the host 102. For example, the controller 130 may provide the data read from the memory device 150, to the host 102, and may store the data provided from the host 102, in the memory device 150. To this end, the controller 130 may control the operations of the memory device 150, such as read, write, program, and erase operations.

The controller 130 may include a host interface 132, a processor 134, an error correction code (ECC) component 138, a power management unit (PMU) 140, a memory interface 142 and a memory 144.

The host interface 132 may process the commands and data of the host 102. The host interface 132 may be configured to communicate with the host 102 through at least one of various interface protocols, such as universal serial bus (USB), multimedia card (MMC), peripheral component interconnect-express (PCI-e or PCIe), serial attached SCSI (SAS), serial advanced technology attachment (SATA), parallel advanced technology attachment (DATA), small computer system interface (SCSI), enhanced small disk interface (ESDI), integrated drive electronics (IDE) and mobile industry processor interface (MIPI). The host interface 132 may be driven through firmware referred to as a host interface layer (HIL) being a region which exchanges data with the host 102.

The ECC component 138 may detect and correct an error contained in the data read from the memory device 150. In other words, the ECC component 138 may perform an error correction decoding process on the data read from the memory device 150 using an ECC code used during an ECC encoding process. According to a result of the error correction decoding process, the ECC component 138 may output a signal, for example, an error correction success/fail signal. When the number of error bits is greater than a threshold number of correctable error bits, the ECC component 138 may not correct the error bits, and instead may output an error correction fail signal.

The ECC component 138 may perform error correction through a coded modulation such as low density parity check (LDDC) code, Bose-Chaudhri-Hocquenghem (BCH) code, turbo code, Reed-Solomon (RS) code, convolution code, recursive systematic code (RSC), trellis-coded modulation (TCM) and block coded modulation (BCM). However, the ECC component 138 is not limited to these correction techniques. As such, the ECC component 138 may include all circuits, modules, systems or devices for suitable error correction.

The PMU 140 may provide and manage the power of the controller 130.

The memory interface 142 may serve as a memory/storage interface which may perform interfacing between the controller 130 and the memory device 150. The memory interface 142 may allow the controller 130 to control the memory device 150 in response to a request from the host 102. The memory interface 142 may generate control signals for the memory device 150 and may process data under the control of the processor 134. The memory interface 142 may be a NAND flash controller (NFC) when the memory device 150 is a flash memory, in particular, when the memory device 150 is a NAND flash memory. The memory interface 142 may support the operation of an interface which may process a command and data between the controller 130 and the memory device 150, for example, a NAND flash interface. In particular, the memory interface 142 may process data input/output between the controller 130 and the memory device 150. The memory interface 142 may be driven through firmware referred to as a flash interface layer (FIL) being a region which exchanges data with the memory device 150.

The memory 144, as the working memory of the memory system 110 and the controller 130, may store data for driving of the memory system 110 and the controller 130. That is, the memory 144 may be an element corresponding to the buffer memory 144 described with reference to FIG. 1. Accordingly, referring to FIGS. 1 and 2, the memory 144 may temporarily store the normal data NORMAL_DATA, read from the non-volatile memory device 150 in a process of controlling, by the controller 130, the non-volatile memory device 150 in response to a request from the host 102, before the normal data NORMAL_DATA is provided to the host 102. Also, the controller 130 may temporarily store normal data NORMAL_DATA provided from the host 102, in the memory 144, before storing the normal data NORMAL_DATA in the memory device 150. When the controller 130 controls read, write, and erase operations of the memory device 150, data NORMAL_DATA, META DATA and JOURNAL_DATA to be transmitted between the controller 130 and the memory device 150 may be stored in the memory 144. For example, the memory 144 may store metadata META DATA and journal data JOURNAL_DATA to perform data write and read operations and normal data NORMAL_DATA when performing the data write and read operations. In order for such data storage, the memory 144 may include a program memory, a data memory, a write buffer/cache, a read buffer/cache, a data buffer/cache, and a map buffer/cache.

The memory 144 may be realized by a volatile memory. For example, the memory 144 may be realized by a static random-access memory (SRAM) or a dynamic random-access memory (DRAM). The memory 144 may be disposed within the controller 130 as illustrated in FIG. 2. Alternatively, the memory 144 may disposed externally to the controller 130. The memory 144 may be realized as an external volatile memory through which data is exchanged with the controller 130 through a separate memory interface.

The processor 134 may control all operations of the memory system 110. In particular, the processor 134 may control a program operation or a read operation for the memory device 150, in response to a write request or a read request from the host 102. The processor 134 may drive firmware which is referred to as a flash translation layer (FTL), to control general operations of the memory system 110. The processor 134 may be realized by a microprocessor or a central processing unit (CPU).

For instance, the controller 130 may perform an operation requested from the host 102, in the memory device 150. That is, the controller 130 may perform a command operation corresponding to a command received from the host 102, with the memory device 150, through the processor 134. The controller 130 may perform a foreground operation as a command operation corresponding to a command received from the host 102. For example, the controller 130 may perform a program operation corresponding to a write command, a read operation corresponding to a read command, an erase operation corresponding to an erase command or a parameter set operation corresponding to a set parameter command or a set feature command as a set command.

The controller 130 may also perform a background operation for the memory device 150, through the processor 134. The background operation for the memory device 150 may include an operation of copying data stored in a memory block among the memory blocks 152, 154 and 156 of the memory device 150 to another memory block, for example, a garbage collection (GC) operation.

In order to control a garbage collection operation as a background operation for the memory device 150, a merge operation control circuit 196 may be included in the processor 134.

The background operation for the memory device 150 may include an operation of swapping data stored in the memory blocks 152, 154 and 156, for example, a wear levelling (WL) operation and a read reclaim (RR) operation. Also, the background operation for the memory device 150 may include an operation of storing map data stored in the controller 130, in the memory blocks 152, 154 and 156 of the memory device 150, for example, a map flush operation, a bad block management operation for the memory device 150, or a bad block management operation of checking and processing a bad block among the plurality of memory blocks 152, 154 and 156 of the memory device 150.

In the processor 134, a management component (not illustrated) for performing bad block management for the memory device 150 may be included. The management component may identify a bad block among the plurality of memory blocks 152, 154 and 156 in the memory device 150, and then, may perform bad block management processing on the identified bad block. When the memory device 150 is a flash memory (for example, a NAND flash memory), a program failure may occur when performing a write operation (program operation), due to the characteristic of the NAND flash memory. The management component may process, as a bad block, a memory block in which the program failure has occurred and may write program-failed data in a different memory block.

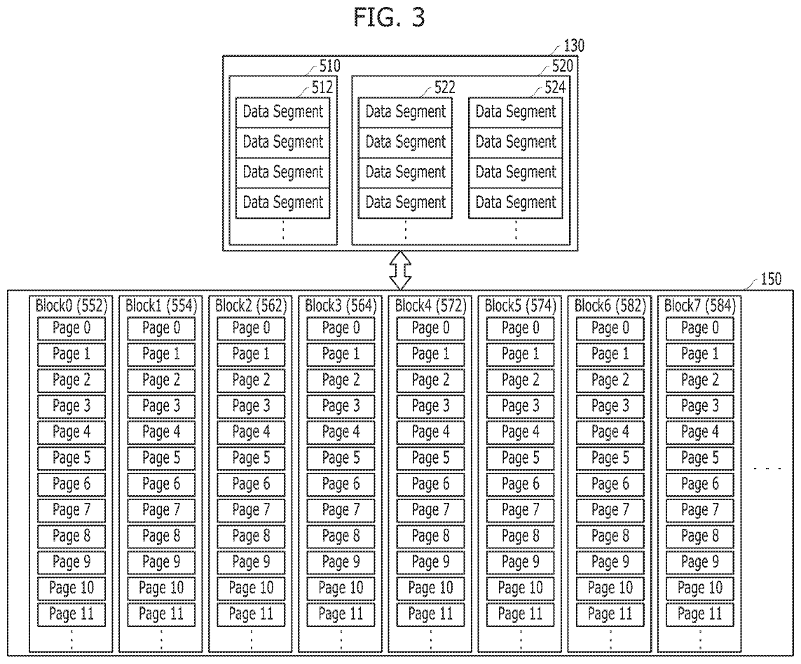

FIG. 3 illustrates an example of a data processing operation which may be performed on a memory device in the memory system according to an embodiment.

Referring to FIG. 3, the controller 130 may receive a program command, program data and logical addresses from the host 102. The controller 130 programs and may store the program data in the plurality of pages in memory blocks 552 to 584 of the memory device 150, in response to the program command.

The controller 130 may generate and update metadata for the program data, and programs and may store the metadata in the memory blocks 552 to 584 of the memory device 150. The metadata may include logical/physical (L2P) information and physical/logical (P2L) information for the program data stored in the memory blocks 552 to 584. Also, the metadata may include information on command data corresponding to a command received from the host 102, information on a command operation corresponding to the command, information on the memory blocks of the memory device 150 on which the command operation is to be performed, and information on map data corresponding to the command operation. In other words, metadata may include all information and data except program data corresponding to a command received from the host 102.

The logical/physical (L2P) information and the physical/logical (P2L) information may refer to physical addresses corresponding to the logical addresses mapped by the controller 130 in response to the program command. The physical addresses may correspond to physical storage spaces of the memory device 150 where the program data received from the host 102 are to be stored.

The controller 130 may store the mapping information between the logical addresses and the physical addresses, that is, the logical/physical (L2P) information and the physical/logical (P2L) information, in at least one memory block among the memory blocks 552 to 584 of the memory device 150. The memory block(s) which may store the logical/physical (L2P) information and the physical/logical (P2L) information may be referred to as system block(s).

For example, the controller 130 caches and buffers the program data corresponding to the program command, in a first buffer 510 in the memory 144 of the controller 130. That is, the controller 130 may store data segments 512 of user data in the first buffer 510 as a data buffer/cache. Thereafter, the controller 130 programs and may store the data segments 512 stored in the first buffer 510, in the pages in the memory blocks 552 to 584 of the memory device 150.

As the data segments 512 of the program data are programmed and stored in the pages in the memory blocks 552 to 584 of the memory device 150, the controller 130 may generate L2P segments 522 and P2L segments 524 as metadata, and may store them in a second buffer 520 in the memory 144 of the controller 130. In the second buffer 520 of the memory 144 of the controller 130, the L2P segments 522 and the P2L segments 524 may be stored in the form of a list. Then, the controller 130 may program and store the L2P segments 522 and the P2L segments 524 stored in the second buffer 520 in the pages in the memory blocks 552 to 584 of the memory device 150 through a map flush operation.

The controller 130 may receive a read command and logical addresses from the host 102. The controller 130 may read L2P segments 522 and P2L segments 524 corresponding to the logical addresses from the memory device 150 and load them in the second buffer 520, in response to the read command. Then, the controller 130 checks physical addresses of the memory device 150 corresponding to the logical addresses from the L2P segments 522 and the P2L segments 524 loaded in the second buffer 520, reads data segments 512 of user data from storage locations identified through the checking. That is, specific pages of specific memory blocks among the memory blocks 552 to 584 may store the data segments 512 in the first buffer 510 and may provide the data segments 512 to the host 102.

As described above, each time a read command and logical addresses are received from the host 102, the controller 130 may read L2P segments 522 and P2L segments 524 corresponding to the logical addresses, and load them in the second buffer 520. Frequently loading L2P segments 522 and P2L segments 524 in this way may degrade performance of the read operation.

As the controller 130 may load a greater amount of L2P segments 522 and P2L segments 524 from the memory device 150 at a time, a single operation of loading L2P segments 522 and P2L segments 524 may involve a greater number of read commands. Therefore, read performance of the memory system 110 may be improved.

L2P segments may be optimized to search for physical addresses corresponding to specific logical addresses. As a result, L2P segments may be efficient in searching for physical addresses to be mapped to logical addresses inputted from the host 102, in a read operation.

P2L segments 524 may be optimized for a program operation. The controller 130 may need to quickly allocate storage spaces in the memory device 150 for storing program data, when receiving a program command, program data and logical addresses from the host 102. In this regard, the controller 130 may load in advance a list of available physical addresses in the second buffer 520. Therefore, at a time when the program command, the program data and the logical addresses are received from the host 102, the controller 130 may quickly search the list of available physical addresses loaded in the second buffer 520. Further, the controller 130 may map physical addresses for the program data, with the logical addresses, and may then store the program data in the storage spaces corresponding to the physical addresses. P2L segments 524 may be generated and temporarily stored in the second buffer 520. The P2L segments 524 stored in the second buffer 520 may be stored in the memory device 150 through a map flush operation.

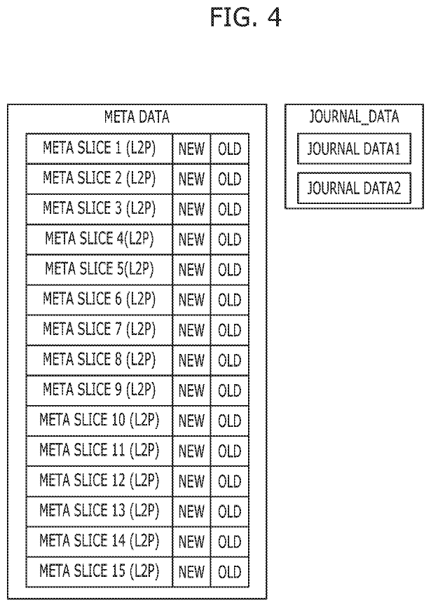

FIG. 4 illustrates the structure of meta data in the memory system according to an embodiment.

Referring to FIGS. 1 to 4 together, in the memory system 110, the meta data META DATA may include logical-physical address mapping information L2P, valid page information VPC, other information ETC, etc. That is, the meta data META_DATA may include all of the remaining pieces of information and data other than the normal data NORMAL_DATA input/output in accordance with a command received from the host 102.

In this case, the logical-physical address mapping information L2P may be mapping information between a logical address LBA received from the host 102 and a physical address PBA indicative of a physical storage space in which normal data NORMAL_DATA corresponding to the logical address LBA will be stored within the non-volatile memory device 150. Furthermore, the valid page information VPC may be information on a page in which valid data is stored, among multiple pages included in a memory block. The controller 130 may control a garbage collection operation based on the valid page information VPC. Furthermore, according to an embodiment, the other information ETC may include reliability information (not illustrated). The reliability information may include erase cycle count information, read count information, etc. for a memory block. The controller 130 may control a read reclaim operation or a wear-leveling operation based on the reliability information.

The controller 130 may split the meta data META DATA into multiple meta slices META SLICE<1:15> and manage the multiple meta slices META SLICE<1:15>. In this case, each of the multiple meta slices META SLICE<1:15> may be information corresponding to at least one of multiple pages within a memory block. The sizes of the multiple meta slices META SLICE<1:15> or the number of multiple meta slices META SLICE<1:15> included in the meta data META DATA may be determined by the type and usage of the non-volatile memory device 150. According to an embodiment, the meta data META DATA may be split into the multiple meta slices META SLICE<1:15> based on a value of a logical address. For reference, the “segment” described with reference to FIG. 3 and the “slice” described with reference to FIG. 4 may mean a data unit; a segment data unit and a slice data unit may be of the same size or different sizes. Furthermore, FIG. 4 illustrates that the number of meta slices META SLICE<1:15> is 15, but this is merely an embodiment. A larger or smaller number of meta slices may be included in meta data.

Specifically, when performing a booting operation, the controller 130 may load, onto the buffer memory 144, meta data META DATA stored in the non-volatile memory device 150, for example, meta data META DATA including logical-physical address mapping information L2P. Furthermore, when it is necessary or desirable to check the mapping information L2P stored in the non-volatile memory device 150, the controller 130 may read, from the non-volatile memory device 150, the meta data META DATA including the mapping information L2P, and may store the read meta data META DATA in the buffer memory 144.

The controller 130 may receive a write command, write data, and a logical address LBA from the host 102. The controller 130 may allocate a physical storage space of the non-volatile memory device 150 in which the write data will be stored, in response to the write command. That is, the controller 130 may map the logical address LBA to a corresponding physical address PBA in response to the write command. In this case, the physical address PBA may indicate a physical storage space of the non-volatile memory device 150 in which the write data received from the host 102 will be stored.

As described above, the controller 130 may map the logical address LBA to the corresponding physical address PBA in response to the write command. In this case, the controller 130 may update meta data META DATA, including mapping information L2P previously stored in the buffer memory 144, with meta data META DATA including newly generated mapping information L2P between the logical address LBA and physical address PBA.

If the update operation is performed, there may be a difference between meta data META DATA including mapping information L2P stored in the non-volatile memory device 150 and meta data META DATA including mapping information L2P stored in the buffer memory 144. Accordingly, the controller 130 may control the pieces of different mapping information L2P to coincide with each other by flushing, into the non-volatile memory device 150, the meta data META DATA including the mapping information L2P stored in the buffer memory 144. That is, the controller 130 may control the meta data META DATA, including the mapping information L2P stored in the buffer memory 144, to coincide with the meta data META DATA, including the mapping information L2P stored in the non-volatile memory device 150, through the flush operation. In this case, the controller 130 may perform the flush operation in a meta slice unit. That is, the controller 130 may select any one updated meta slice of the multiple meta slices META SLICE<1:15>, and may store the selected meta slice in the non-volatile memory device 150 by performing the flush operation on the selected meta slice.

More specifically, the controller 130 may classify, as a dirty meta slice, an updated meta slice among the multiple meta slices META SLICE<1.:15> buffered in the buffer memory 144. Furthermore, the controller 130 may perform the flush operation on the dirty meta slice among the multiple meta slices META SLICE<1:15>, that is, an operation of writing the dirty meta slices in the non-volatile memory device 150. In this case, if there are several dirty meta slices among the multiple meta slices META SLICE<1.:15> buffered in the buffer memory 144, the controller 130 may select any one of the several dirty meta slices, and may perform the flush operation on the selected dirty meta slice. Furthermore, the controller 130 may select the dirty meta slice among the multiple meta slices META SLICE<1:15> buffered in the buffer memory 144 in a round robin manner, and may perform the flush operation on the selected dirty meta slice.

Furthermore, the controller 130 may generate first state information NEW and second state information OLD for each of the multiple meta slices META SLICE<1:15> buffer memory 144. In this case, the first state information NEW and the second state information OLD corresponding to each of the multiple meta slices META SLICE<1:15> may be stored in the buffer memory 144 along with the multiple meta slices META SLICE<1:15>.

Specifically, the controller 130 may classify updated meta slices among the multiple meta slices META SLICE<1:15> as first dirty slices by adjusting, i.e., setting or changing, first state information NEW of the updated meta slices to indicate such classification. Furthermore, the controller 130 may classify flushed first dirty slices of the first dirty slices as second dirty slices by adjusting, i.e., setting or changing, both first state information NEW and second state information OLD of the flushed first dirty slices to indicate such classification. Furthermore, the controller 130 may classify flushed second dirty slices of the second dirty slices as clean meta slices by adjusting, i.e., setting or changing, second state information OLD of the flushed second dirty slices to indicate such classification. Furthermore, the controller 130 may classify updated second dirty slices of the second dirty slices as third dirty slices by adjusting, i.e., setting or changing, first state information NEW of the updated second dirty slices to indicate such classification. Furthermore, the controller 130 may classify flushed third dirty slices of the third dirty slices as the second dirty slice by adjusting, i.e., setting or changing, first state information NEW of the flushed third dirty slices to indicate such classification.

In this case, a clean meta slice has the same value in both the buffer memory 144 and the non-volatile memory device 150.

As described above, the controller 130 may adjust values of the first state information NEW and second state information OLD corresponding to each of the multiple meta slices META SLICE<1:15> depending on whether an update operation or a flush operation is performed on each of the multiple meta slices META SLICE<1:15>. Accordingly, the controller 130 may classify the state of each of the multiple meta slices META SLICE<1:15> as a clean meta slice, a first dirty slice, a second dirty slice, and a third dirty slice.

More specifically, the controller 130 may classify an updated meta slice of the multiple meta slices META SLICE<1:15> as a first dirty slice. Furthermore, the controller 130 may classify the flushed first dirty slice as a second dirty slice by performing a flush operation on the first dirty slice. Furthermore, the controller 130 may classify the flushed second dirty slice as a clean meta slice by performing a flush operation on the second dirty slice. Furthermore, the controller 130 may classify the updated second dirty slice as a third dirty slice by performing an update operation on the second dirty slice. Furthermore, the controller 130 may classify the flushed third dirty slice as a second dirty slice by performing a flush operation on the third dirty slice.

In this case, the controller 130 may permit the update operation for a dirty slice while the flush operation is being performed on the dirty slice. in other words, while a dirty slice is being flushed, an update operation may still be performed on that data slice, because the controller 130 may define different states for each of the multiple meta slices META SLICE<1:15> by setting or changing first state information NEW and second state information OLD for each of the multiple meta slices META SLICE<1:15>.

For example, the first dirty slice is classified as the second dirty slice when the flush operation is performed on the first dirty slice. When the second dirty slice is updated while the flush operation is performed thereon, the second dirty slice may be classified as the third dirty slice. When the second dirty slice is not updated while the flush operation is performed thereon, it may continue to be classified as the second dirty slice.

Likewise, the second dirty slice is classified as the clean slice when the flush operation is performed on the second dirty slice. When the clean slice is updated while the flush operation is performed thereon, the clean slice may be classified as the first dirty slice. When the clean slice is not updated while the flush operation is performed thereon, it may continue to be classified as the clean slice.

Likewise, the third dirty slice is classified as the second dirty slice when the flush operation is performed on the third dirty slice. When the second dirty slice is updated while the flush operation is performed thereon, it may be classified as the third dirty slice again. When the second dirty slice is not updated while the flush operation is performed thereon, it may continue to be classified as the second dirty slice.

Furthermore, the controller 130 may generate journal data JOURNAL_DATA. The journal data JOURNAL_DATA may represent an update history of the meta data META DATA. Accordingly, the controller 130 may recover a previously updated meta data META DATA based on the journal data JOURNAL_DATA. For example, the journal data JOURNAL_DATA may include information indicative of a type of an operation of changing the meta data META DATA and data for restoring the change in the meta data META DATA. In this case, the information indicative of the type of an operation of changing the meta data META DATA may include pieces of information that respectively define all types of operations capable of changing the meta data META DATA, such as a write operation, an operation of allocating a memory block, and an operation of copying data stored in a page. Furthermore, the data for restoring the change in the meta data META DATA may include a logical address, a previous physical address, and a new physical address.

Furthermore, the controller 130 may store, in the non-volatile memory device 150, journal data JOURNAL_DATA generated therein by performing a flush operation on the journal data JOURNAL_DATA. In this case, the flush operation for the journal data JOURNAL_DATA may be performed only when the size of the journal data JOURNAL_DATA is a set size. Specifically, the controller 130 may store the journal data JOURNAL_DATA in the buffer memory 144. In particular, in order to store two pieces of journal data JOURNAL_DATA<1:2> in the buffer memory 144, the controller 130 may reserve two spaces in which data having a set size can be stored. The controller 130 may select a first storage space of the two storage spaces, reserved for the storage of the journal data, in the buffer memory 144, and may store first journal data JOURNAL_DATA1 in the first storage space. If the first journal data JOURNAL_DATA1 stored in the first storage space of the buffer memory 144 has the set size, the controller 130 may set, i.e., characterize, the first journal data JOURNAL_DATA1 as journal retention data, and may write the first journal data JOURNAL_DATA1 in the non-volatile memory device 150 by performing a flush operation on the journal retention data. In this case, the controller 130 may set or characterize, as new journal data, second journal data JOURNAL_DATA2 newly generated due to the update of the meta data META DATA and store the second journal data JOURNAL_DATA2 in the buffer memory 144, while the first journal data JOURNAL_DATA1 set as the journal retention data is written in the non-volatile memory device 150, that is, even when the flush operation for the first journal data JOURNAL_DATA1 set as the journal retention data has not been completed. That is, separately from the execution of the flush operation for the first journal data JOURNAL_DATA1 set as the journal retention data, the controller 130 may select a second storage space of the two storage spaces, reserved for the storage of the journal data, in the buffer memory 144, and may store, in the second storage space, the second journal data JOURNAL_DATA2 set as the new journal data. When the flush operation for the first journal data JOURNAL_DATA1 set as the journal retention data is completed, that is, when an operation of writing the first journal data JOURNAL_DATA1, set as the journal retention data, in a storage space within the non-volatile memory device 150 is completed, the controller 130 may delete or invalidate, from the buffer memory 144, the first journal data JOURNAL_DATA1. stored in the first storage space of the two storage spaces reserved for the storage of journal data.

As described above, separately from the execution of the flush operation for the first journal data JOURNAL_DATA1 set as the journal retention data, the controller 130 has performed the operation of selecting the second storage space of the two storage spaces, reserved for the storage of the journal data, in the buffer memory 144 and storing, in the second storage space, the second journal data JOURNAL_DATA2 set as the new journal data. In this case, if the second journal data JOURNAL_DATA2 stored in the second storage space of the buffer memory 144 has the set size, the controller 130 may set the second journal data JOURNAL_DATA2 as the journal retention data, and may write the second journal data JOURNAL_DATA2 in the non-volatile memory device 150 by performing a flush operation on the journal retention data. In this case, the controller 130 may set, as new journal data, the first journal data JOURNAL newly generated due to the update of the meta data META DATA and store the first journal data JOURNAL_DATA1 in the buffer memory 144 while the second journal data JOURNAL_DATA2 set as the journal retention data is written in the non-volatile memory device 150, that is, even in the state in which the flush operation for the second journal data JOURNAL_DATA2 set as the journal retention data has not been completed. That is, separately from the execution of the flush operation for the second journal data JOURNAL_DATA2 set as the journal retention data, the controller 130 may select the first storage space of the two storage spaces, reserved for the storage of the journal data, in the buffer memory 144, and may store, in the first storage space, the first journal data JOURNAL_DATA1 set as the new journal data. When the flush operation for the second journal data JOURNAL_DATA2 set as the journal retention data is completed, that is, when an operation of writing the second journal data JOURNAL_DATA2 in a storage space within the non-volatile memory device 150 is completed, the controller 130 may delete or invalidate, from the buffer memory 144, the second journal data JOURNAL stored in the second storage space of the two storage spaces reserved for the storage of journal data.

As described above, the controller 130 according to an embodiment may reserve two storage spaces of the buffer memory 144 for the storage of journal data and may alternately use the two storage spaces. Accordingly, the controller 130 may generate new journal data JOURNAL_DATA even while a flush operation for the journal data JOURNAL_DATA having the set size, that is, an operation of writing the journal data JOURNAL_DATA in the non-volatile memory device 150, is performed. In this case, if new journal data can be generated, this may mean that the execution of an update operation for meta data META DATA is permitted. Accordingly, the controller 130 may permit the execution of the update operation for the meta data META DATA, for example, in the state in which the journal data JOURNAL_DATA has the set size and a flush operation is performed thereon or in the state in which the journal data JOURNAL_DATA has a size smaller than the set size, regardless of a state of the journal data JOURNAL_DATA. As described above, the controller 130 permits the execution of the update operation for the meta data META DATA regardless of the state of the journal data JOURNAL_DATA. Thus, the controller 130 may perform a flush operation on the meta data META DATA regardless of the state of the journal data JOURNAL_DATA. For example, as a result of the check of the state of each of the multiple meta slices META SLICE<1:15>, stored in the buffer memory 144, in the state in which the journal data JOURNAL_DATA has a size smaller than the set size, if any one of the first dirty slice, the second dirty slice, and the third dirty slice is present, the controller 130 may perform a flush operation on a corresponding slice.

On the other hand, the controller 130 according to an embodiment may flush at least one of the first to third dirty slices in a state in which the journal data JOURNAL_DATA has a size smaller than a set size by moving the at least one of the first to third dirty slices to a reserved space (not show) of the buffer memory 144. Thereafter, when flushing the journal data JOURNAL_DATA of the set size, the controller may write the at least one of the first to third dirty slices moved to the reserved space of the buffer memory 144 together with the journal data JOURNAL_DATA of the set size in the non-volatile memory device.

Here, the controller 130 according to an embodiment may split the at least one of the first to third dirty slices into a size unit and i0 may move the split slices to the reserved space of the buffer memory 144 at set times. Further, the controller 130 may check a size of the journal data JOURNAL_DATA smaller than the set size at the time at which moving of the at least one of the first to third dirty slices to the reserved space of the buffer memory 144 is started, and may determine the size unit and the set times based on a result of the check.

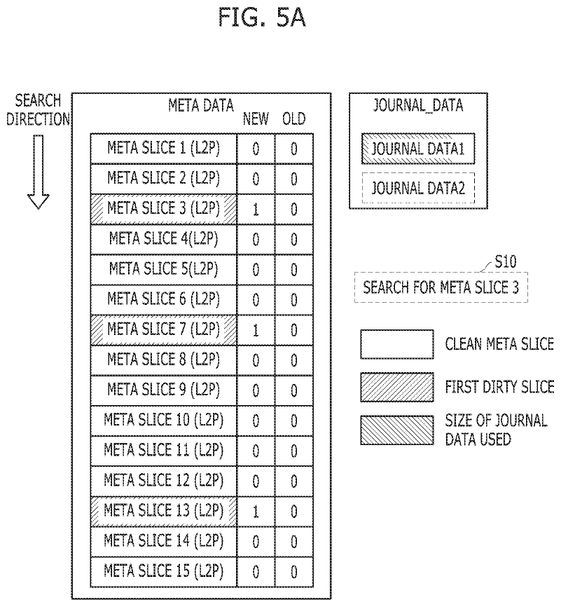

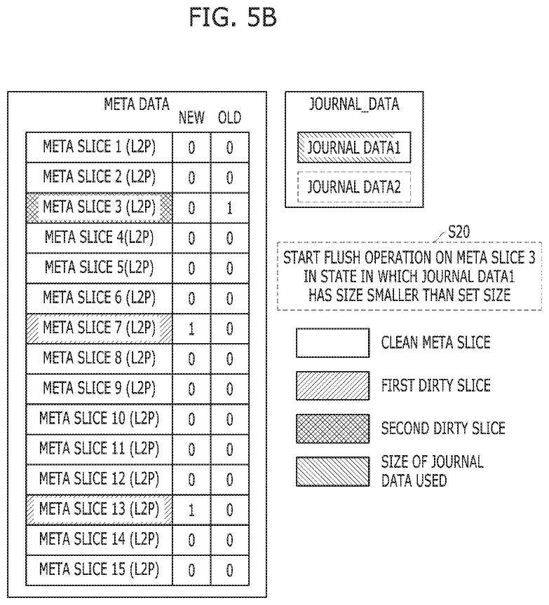

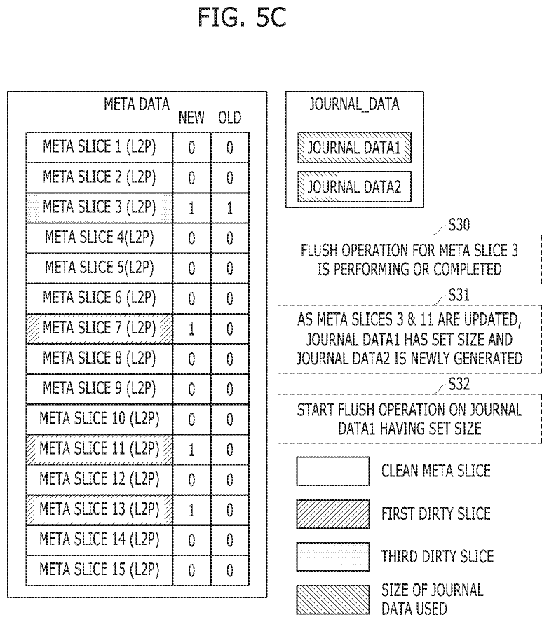

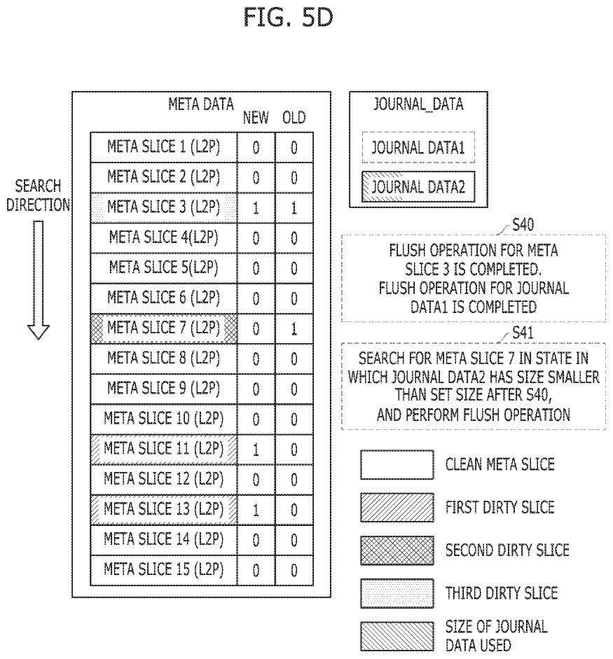

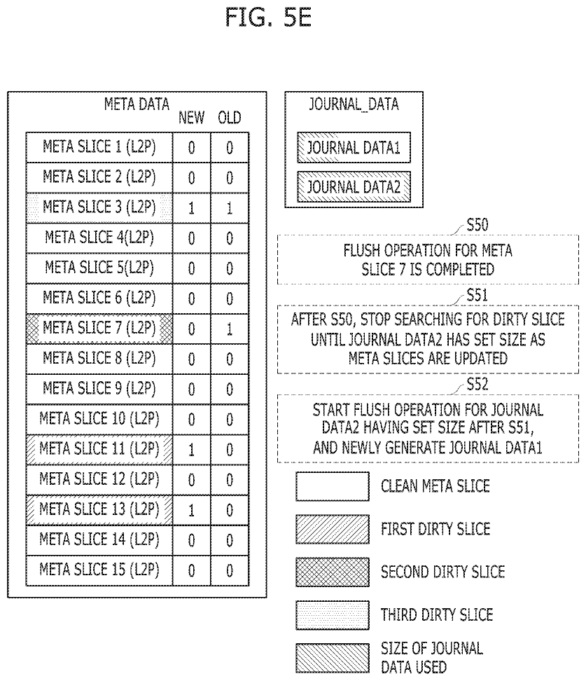

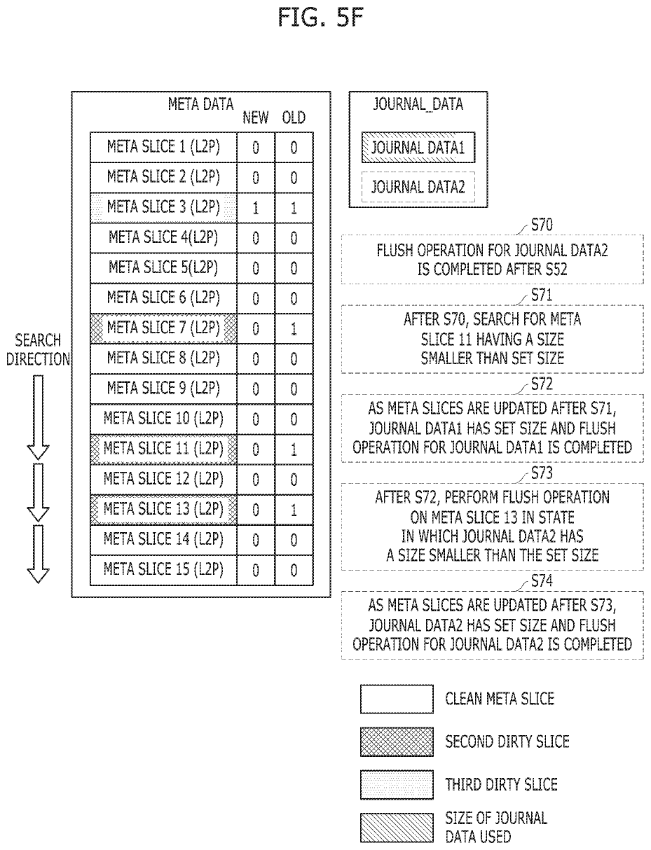

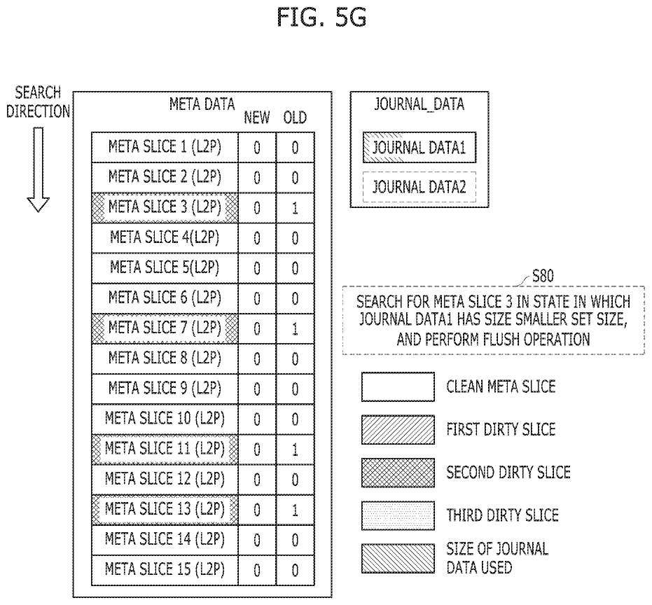

FIGS. 5A to 5G illustrate a method of managing meta data in the memory system according to an embodiment.

Referring to FIG. 5A, the controller 130 may check the state of each of the multiple meta slices META SLICE<1:15>, stored in the buffer memory 144, in a round robin manner,

For example, in FIG. 5A, a third meta slice META SLICE 3, a seventh meta slice META SLICE 7, and a thirteenth meta slice META SLICE 13, among the multiple meta slices META SLICE<1:15> stored in the buffer memory 144, may be classified as first dirty slices. That is, in FIG. 5A, the controller 130 may classify each of the third meta slice META SLICE 3, the seventh meta slice META SLICE 7, and the thirteenth meta slice META SLICE 13 as a first dirty slice by setting, to “1”, the first state information NEW of each of the third meta slice META SLICE 3, the seventh meta slice META SLICE 7, and the thirteenth meta slice META SLICE 13, and setting, to “0”, the second state information OLD of each of the third meta slice META SLICE 3, the seventh meta slice META SLICE 7, and the thirteenth meta slice META SLICE 13. In FIG. 5A, the controller 130 may classify each of the remaining meta slices META SLICE<1, 2, 4:6, 8:12, 14, 15> as clean meta slices by setting, to an initial value of “0”, both the first state information NEW and second state information OLD of each of the remaining meta slices META SLICE<1, 2, 4:6, 8:12, 14, 15>.

In such a state, the controller 130 may check the state of each of the multiple meta slices META SLICE<1:15> stored in the buffer memory 144 in a round robin manner. As a result of the check, the controller 130 may be aware that the third meta slice META SLICE 3 is classified as a first dirty slice (S10).

Referring to FIG. 5B, as the controller 130 has checked that the third meta slice META SLICE 3 is classified as the first dirty slice, the controller 130 may start a flush operation on the third meta slice META SLICE 3 even in the state in which the first journal data JOURNAL_DATA1 has a size smaller than a set size (S20). In this case, the controller 130 may adjust the first state information NEW of the third meta slice META SLICE 3, stored in the buffer memory 144, from “1” to “0” and the second state information OLD of the third meta slice META SLICE 3 from “0” to “1” at the time at which the flush operation for the third meta slice META SLICE 3 is started. That is, the controller 130 may classify, as a second dirty slice, the third meta slice META SLICE 3, stored in the buffer memory 144, when the flush operation for the third meta slice META SLICE 3 is started.

Referring to FIG. 5C, the controller 130 may be performing or have completed the flush operation for the third meta slice META SLICE 3 (S30). In the state in which the controller 130 is performing or has completed the flush operation for the third meta slice META SLICE 3 as described above, the third meta slice META SLICE 3 may be updated, and thus the first journal data JOURNAL_DATA1 may have the set size (S31). In this case, as described with reference to FIG. 5B, the third meta slice META SLICE 3 stored in the buffer memory 144 is classified as the second dirty slice at the time at which the flush operation for the third meta slice META SLICE 3 is started. Accordingly, the third meta slice META SLICE 3 stored in the buffer memory 144 may be classified as a third dirty slice again in response to the update of the third meta slice META SLICE 3, That is, as described with reference to FIG. 5B, when the flush operation for the third meta slice META SLICE 3 is started, the controller 130 has classified, as a second dirty slice, the third meta slice META SLICE 3, stored in the buffer memory 144, by setting the first and second state information NEW and OLD of the third meta slice META SLICE 3 to “0” and “1”, respectively. In such a state, when an update operation is performed on the third meta slice META SLICE 3, the controller 130 may classify, as a third dirty slice, the third meta slice META SLICE 3 stored in the buffer memory 144, by setting the first and second state information NEW and OLD of the third meta slice META SLICE 3 to “1” and “1”, respectively.

Furthermore, as the eleventh meta slice META SLICE 11 is updated in the state in which the first journal data JOURNAL_DATA1 has the set size, the second journal data JOURNAL_DATA2 may be newly generated (531). In this case, the controller 130 may classify the updated eleventh meta slice META SLICE 11 as a first dirty slice by setting the first state information NEW of the updated eleventh meta slice META SLICE 11 to “1” and second state information OLD of the updated eleventh meta slice META SLICE 11 to “0.” Furthermore, since the first journal data JOURNAL has the set size, the controller 130 may start a flush operation on the first journal data JOURNAL_.DATA1 having the set size (S32), For reference, in FIG. 5C, the time period during which the flush operation for the third meta slice META SLICE 3 is performed and the time period during which the flush operation for the first journal data JOURNAL_DATA1 is performed may or may not overlap.

Referring to FIG. 5D, it may be assumed that the flush operation for the third meta slice META SLICE 3 started in FIG. 5B has been completed in FIG. 5D. Furthermore, it may be assumed that the flush operation for the first journal data JOURNAL_DATA1 started in FIG. 5C has been completed in FIG. 5D (S40).

Accordingly, the controller 130 may delete or invalidate the first journal data JOURNAL_DATA1 from the buffer memory 144.

Furthermore, the controller 130 may check the state of each of the multiple meta slices META SLICE<1:15> stored in the buffer memory 144 in a round robin manner. In this case, since each of the meta data slices up to the third meta slice META SLICE 3 has already been checked as indicated in FIG. 5A, the controller 130 may check the state of each of the remaining meta slices from the fourth meta slice META SLICE 4 as indicated in FIG. 5D. For this reason, although the third meta slice META SLICE 3 is classified as a third dirty slice, the controller 130 does not search for the third meta slice META SLICE 3, but may search for the seventh meta slice META SLICE 7. That is, the controller 130 may check the state of each of the fourth to seventh meta slices META SLICE<4:7>, and may be aware that the seventh meta slice META SLICE 7 is classified as a first dirty slice, as a result of the check (541).

As described above, since the controller 130 has checked that the seventh meta slice META SLICE 7 is classified as the first dirty slice, the controller 130 may start a flush operation on the seventh meta slice META SLICE 7 even in the state in which the second journal data JOURNAL_DATA2 has a size smaller than the set size (S41).

In this case, the controller 130 may change the first state information NEW of the seventh meta slice META SLICE 7, stored in the buffer memory 144, from “1” to “0” and the second state information OLD of the seventh meta slice META SLICE 7 from “0” to “1” at the time at which the flush operation for the seventh meta slice META SLICE 7 is started. That is, the controller 130 may classify, as a second dirty slice, the seventh meta slice META SLICE 7, stored in the buffer memory 144, when the flush operation for the seventh meta slice META SLICE 7 is started.

Referring to FIG. 5E, it may be assumed that the flush operation for the seventh meta slice META SLICE 7 started in FIG. 5D has been completed in FIG. 5E (S50).

Although the flush operation for the seventh meta slice META SLICE 7 has been completed as described above, the controller 130 may stop an operation of searching for another dirty slice until the second journal data JOURNAL_DATA2 has the set size (S51), This is for enabling a flush operation for journal data and a flush operation for a meta slice to be alternately performed. The reason for this is that if one item of journal data is flushed while several meta slices are flushed as a result of being classified as dirty slices, meta data may be difficult to recover when restored using the journal data. Accordingly, the controller 130 according to an embodiment may use a method of alternately flushing journal data and meta data.

As the update of the multiple meta slices META SLICE<1:15>is repeated over time, the second journal data JOURNAL_DATA2 may have the set size. Accordingly, the controller 130 may start a flush operation for the second journal data JOURNAL_DATA2 having the set size (S52). In the state in which the flush operation for the second journal data JOURNAL_DATA2 has been started, the controller 130 may newly generate the first journal data JOURNAL_DATA1 (S52). For reference, it may be assumed that although not directly illustrated in the drawings, an update operation for the multiple meta slices META SLICE<1:15> is repeatedly performed until the second journal data JOURNAL_DATA2, having a size smaller than the set size, has the set size.

Referring to FIG. 5F, it may be assumed that the aforementioned operations described with reference to FIGS. 5A to 5E are repeated.

Specifically, it may be assumed that the flush operation for the second journal data JOURNAL_.DATA2 started in FIG. 5E has been completed in FIG. 5F (S70). In this case, the controller 130 may be newly generate the first journal data JOURNAL according to the operation of updating the meta slices, regardless of the completion of the flush operation for the second journal data JOURNAL_DATA2.

Furthermore, since the flush operation for the second journal data JOURNAL_DATA2 has been completed, the controller 130 may restart an operation of searching for another dirty slice and thus check that the eleventh meta slice META SLICE 11 has been classified as the first dirty slice. Accordingly, the controller 130 may perform a flush operation on the eleventh meta slice META SLICE 11 even in the state in which the first journal data JOURNAL_DATA1 has a size smaller the set size (S71).

After the flush operation for the eleventh meta slice META SLICE 11 is completed, the controller 130 may stop the operation of searching for another dirty slice until the first journal data JOURNAL_DATA1 has the set size as the meta slices are updated.

As the update of the multiple meta slices META SLICE<1:15>is repeated over time, the first journal data JOURNAL_DATA1 may have the set size. Accordingly, the controller 130 may start a flush operation for the first journal data JOURNAL_DATA1 having the set size (S72).

In this case, the controller 130 may newly generate the second journal data JOURNAL_.DATA2 according to the operation of updating the meta slices, regardless of the completion of the flush operation for the first journal data JOURNAL_DATA1.

Furthermore, when the flush operation for the first journal data JOURNAL_DATA1 is completed, the controller 130 may restart an operation of searching for another dirty slice and thus check that the thirteenth meta slice META SLICE 13 is classified as A first dirty slice. Accordingly, the controller 130 may perform a flush operation on the thirteenth meta slice META SLICE 13 even in the state in which the second journal data JOURNAL_DATA2 has a size smaller than the set size (S73).

After the flush operation for the thirteenth meta slice META SLICE 13 is completed, the controller 130 may stop the operation of searching for another dirty slice until the second journal data JOURNAL_DATA2 has the set size as the meta slices are updated.

As the update of the multiple meta slices META SLICE<1:15>is repeated over time, the second journal data JOURNAL_DATA2 may have the set size. Accordingly, the controller 130 may start a flush operation for the second journal data JOURNAL_DATA2 having the set size (S74).

In this case, the controller 130 may newly generate the first journal data JOURNAL_DATA1 according to the operation of updating the meta slices, regardless of the completion of the flush operation for the second journal data JOURNAL_DATA2.

Furthermore, when the flush operation for the second journal data JOURNAL_DATA2 is completed, the controller 130 may restart an operation of searching for another dirty slice and thus complete an operation of checking once the states of all the multiple meta slices META SLICE<1:15> in a round robin manner.

Referring to FIG. 5G, since the operation of checking once the respective states of the multiple meta slices META SLICE<1:15>, stored in the buffer memory 144, in a round robin manner has been completed in FIG. 5F, the controller 130 may recheck the state of each of the multiple meta slices META SLICE<1:15> in a round robin manner.

Accordingly, the controller 130 may check the state of each of the multiple meta slices META SLICE<1:15>, stored in the buffer memory 144, in a round robin manner, and can be aware that the third meta slice META SLICE 3 has been classified as the third dirty slice, as a result of the check (S80).

As described above, since the controller 130 has checked that the third meta slice META SLICE 3 has been classified as the third dirty slice, the controller 130 may start a flush operation for the third meta slice META SLICE 3 even in the state in which the first journal data JOURNAL_DATA1 has a size smaller the set size (S80). In this case, the controller 130 may adjust the first state information NEW of the third meta slice META SLICE 3, stored in the buffer memory 144, from “1” to “0” and continue to maintain the second state information OLD of the third meta slice META SLICE 3 to “1”, at the time at which the flush operation for the third meta slice META SLICE 3 is started. That is, the controller 130 may classify, as the second dirty slice, the third meta slice META SLICE 3, stored in the buffer memory 144, when the flush operation for the third meta slice META SLICE 3 is started.

According to embodiments of the present invention, when multiple meta slices included in meta data and journal data corresponding to the update of a meta slice are written in the non-volatile memory device, operations of writing the meta slice and writing the journal data are asynchronously performed. Accordingly, an update of a meta slice on which a write operation is performing can be permitted.

Accordingly, embodiments of the invention advantageously reduce or minimize the amount of time taken to write meta data, and thus performance of the entire memory system can be improved.

Although various embodiments have been illustrated and described, it will be apparent to those skilled in the art that various changes and modifications may be made without departing from the spirit and scope of the disclosure as defined in the following claims.

What is claimed is:

1. A memory system comprising:
a non-volatile memory device;
a controller suitable for generating meta data in accordance with normal data being stored in the non-volatile memory device; and
a buffer memory suitable for storing multiple meta slices configuring the meta data,
wherein the controller
classifies each updated slice of the multiple meta slices as a first dirty slice using first state information of the corresponding updated slice,
classifies each flushed slice of the first dirty slices as a second dirty slice by using the first and second state information of the corresponding flushed slice,
classifies each flushed slice of the second dirty slices as the meta slice using the second state information of the corresponding flushed slice,
classifies each updated slice of the second dirty slices as a third dirty slice using the first state information of the updated slice,
classifies each flushed slice of the third dirty slices as the second dirty slice using the first state information of the flushed slice, and
enables update of each of the first to third dirty slices while flushing each of the first to third dirty slices,
wherein the first and second state information for each of the multiple meta slices is stored in the buffer memory.

2. The memory system of claim 1, wherein the controller
generates first journal data comprising information on the update of the first to third dirty slices and stores the first journal data in the buffer memory,
flushes at least one of the first to third dirty slices when the at least one dirty slice is present in a state in which the first journal data has a size smaller than a set size,
flushes the first journal data by changing the first journal data into journal retention data when the first journal data has the set size, and
generates second journal data comprising update information on the first to third dirty slices after the flushing of the first journal retention data is started, and stores the second journal data in the buffer memory.

3. The memory system of claim 2, wherein the second journal data is stored in a different location in the buffer memory than the location at which the journal retention data is stored in the buffer memory.

4. The memory system of claim 2,
wherein the controller flushes at least one of the first to third dirty slices by writing at least one of the first to third dirty slices, and
wherein the controller flushes the journal retention data by writing the journal retention data in the non-volatile memory device.

5. The memory system of claim 2, wherein the controller flushes at least one of the first to third dirty slices in a state in which the first journal data has a size smaller than a set size by:
moving the at least one of the first to third dirty slices to a reserved space of the buffer memory, and
writing, when flushing the journal retention data, the at least one of the first to third dirty slices moved to the reserved space together with the journal retention data in the non-volatile memory device.

6. The memory system of claim 5, wherein the controller moves the at least one of the first to third dirty slices by:
splitting the at least one of the first to third dirty slices by a size unit, and
moving the split slices at set times.

7. The memory system of claim 6, wherein the controller
checks a size of the first journal data at the time at which moving of the at least one of the first to third dirty slices to the reserved space is started, and
determines the size unit and the set times based on a result of the check.

8. The memory system of claim 2,
wherein the controller:
searches the multiple meta slices for the first to third dirty slices in a round robin manner, and
flushes the first to third dirty slices retrieved in the search.

9. The memory system of claim 8, wherein the controller searches for the first to third dirty slices from a next meta slice of a previously retrieved meta slice, when the second journal data is generated after the flushing of the journal retention data is started.

10. The memory system of claim 1,
wherein the controller:
sets initial values of the first and second state information to “0” and “0”, respectively,
classifies each of the first dirty slices by setting a value of the first state information of the updated slice to “1”,
classifies each of the second dirty slices by setting values of the first and second state information of the flushed slice to “0” and “1”, respectively,
classifies each of the meta slices by setting a value of the second state information of the flushed slice to “0”,
classifies each of the third dirty slices by setting a value of the first state information of the updated slice to “1”, and
classifies each of the second dirty slices by setting a value of the first state information of the flushed slice to “0.”

11. An operating method of a memory system comprising a non-volatile memory device and a buffer memory, the operating method comprising:
generating meta data configured with multiple meta slices in accordance with normal data being stored in the non-volatile memory device;
storing the meta data and the first and second state information in the buffer memory;
classifying, in a first classifying operation, each updated slice of the multiple meta slices as a first dirty slice using first state information of the corresponding updated slice;
classifying, in a second classifying operation, each flushed slice of the first dirty slices as a second dirty slice using the first information and second state information of the corresponding flushed slice;
classifying, in a third classifying operation, each flushed slice of the second dirty slices as the meta slice using the second state information of the corresponding flushed slice;
classifying, in a fourth classifying operation, each updated slice of the second dirty slices as a third dirty slice using the first state information of the corresponding updated slice; and
classifying, in a fifth classifying operation, each flushed slice of the third dirty slices as the second dirty slice using the first state information of the corresponding flushed slice,
wherein update of each of the first to third dirty slices is enabled while flushing each of the first to third dirty slices.

12. The operating method of claim 11, further comprising:
generating first journal data comprising information of the update of the first to third dirty slices and storing the first journal data in the buffer memory;
flushing, in a first flush operation, at least one of the first to third dirty slices when the at least one dirty slice is present in a state in which the first journal data has a size smaller than a set size;
flushing, in a second flush operation, the first journal data by changing the first journal data to journal retention data when the first journal data has the set size; and
generating second journal data comprising update information corresponding to the first to third dirty slices after the flushing of the first journal retention data is started, and storing the second journal data in the buffer memory.

13. The operating method of claim 12, wherein the second journal data is stored in a different location in the buffer memory than the location at which the journal retention data is stored in the buffer memory.

14. The operating method of claim 12, wherein:
the first flush operation comprises writing any one of the first to third dirty slices in the non-volatile memory device, and
the second flush operation comprises writing the journal retention data in the non-volatile memory device.

15. The operating method of claim 12, wherein the first flush operation comprises:
moving the at least one of the first to third dirty slices to a reserved space of the buffer memory, and
writing, during the second flush operation, the at least one of the first to third dirty slices moved to the reserved space together with the journal retention data in the non-volatile memory device.

16. The operating method of claim 15, wherein the moving of the at least one of the first to third dirty slices includes:
splitting the at least one of the first to third dirty slices by a size unit, and
moving the split slices at set times.

17. The operating method of claim 16, further comprising:
checking a size of the first journal data at the time at which moving of the at least one of the first to third dirty slices to the reserved space is started, and
determining the size unit and the timing based on a result of the checking.

18. The operating method of claim 12,
further comprising searching the multiple meta slices for the first to third dirty slices in a round robin manner, and
wherein in the first flush operation is performed on the searched first to third dirty slices.

19. The operating method of claim 18, wherein the first to third dirty slices are searched from a meta slice next to one among the first to third dirty slices that is previously searched when the second journal data is generated after the flushing of the journal retention data is started.

20. The operating method of claim 11, further comprising:
setting initial values of the first and second state information to “0” and “0”, respectively, wherein
in the first classification operation, the first dirty slices are classified by setting a value of the first state information of the updated slices among the multiple meta slices to “1”,
in the second classification operation, the second dirty slices are classified by setting values of the first and second state information of the flushed slices among the first dirty slices to “0” and “1”, respectively,
in the third classification operation, the meta slices are classified by setting a value of the second state information of the flushed slices among the second dirty slices to “0”,
in the fourth classification operation, the third dirty slices are classified by setting a value of the first state information of the updated slices among the second dirty slices to “1”, and
in the fifth classification operation, the second dirty slices are classified by setting a value of the first state information of the flushed slices among the third dirty slices to “0.”
